(19) United States
(12) Patent Application Publication
(10) Pub. No.: US 2004/0130567 A1
(43) Pub. Date: Jul. 8, 2004

(54) Automatic soccer video analysis and summarization

(76) Inventors: Ahmet Ekin, Eindhoven (NL); A. Murat Tekalp, Rochester, NY (US)

Correspondence Address: BLANK ROME LLP, 600 NEW HAMPSHIRE AVENUE, N.W., WASHINGTON, DC, 20037, US

(21) Appl. No.: 10/632,110

(22) Filed: Aug. 1, 2003

Related U.S. Application Data
(60) Provisional application No. 60/400,067, filed on Aug. 2, 2002.

(51) Int. Cl. G09G 5/00

(52) U.S. Cl. 345/723

(57) ABSTRACT

The system automatically extracts cinematic features, such as shot types and replay segments, and object-based features, such as the features to detect referee and penalty box objects. The system uses only cinematic features to generate real-time summaries of soccer games, and uses both cinematic and object-based features to generate near real-time, but more detailed, summaries of soccer games. The techniques include dominant color region detection, which automatically learns the color of the play area and automatically adjusts with environmental conditions, shot boundary detection, shot classification, goal event detection, referee detection and penalty box detection.

### REFERENCE TO RELATED APPLICATION

The present application claims the benefit of U.S. Provisional Application No. 60/400,067, filed Aug. 2, 2002, whose disclosure is hereby incorporated by reference in its entirety into the present disclosure.

### STATEMENT OF GOVERNMENT INTEREST

The work leading to the present invention has been supported in part by National Science Foundation grant no. IIS-9820721. The government has certain rights in the invention.

### FIELD OF THE INVENTION

The present invention is directed to the automatic analysis and summarization of video signals and more particularly to such analysis and summarization for transmitting soccer and other sports programs with more efficient use of bandwidth.

### DESCRIPTION OF RELATED ART

Sports video distribution over various networks should contribute to quick adoption and widespread usage of multimedia services worldwide, since sports video appeals to wide audiences. Since the entire video feed may require more bandwidth than many potential viewers can spare, and since the valuable semantics (the information of interest to the typical sports viewer) in a sports video occupy only a small portion of the entire content, it would be useful to be able to conserve bandwidth by sending a reduced portion of the video which still includes the valuable semantics. On the other hand, since the value of a sports video drops significantly after a relatively short period of time, any processing on the video must be completed automatically in real-time or in near real-time to provide semantically meaningful results. Semantic analysis of sports video generally involves the use of both cinematic and object-based features. Cinematic features are those that result from common video composition and production rules, such as shot types and replays. Objects are described by their spatial features, e.g., color, and by their spatio-temporal features, e.g., object motions and interactions. Object-based features enable high-level domain analysis, but their extraction may be computationally costly for real-time implementation. Cinematic features, on the other hand, offer a good compromise between the computational requirements and the resulting semantics.

In the literature, object color and texture features are employed to generate highlights and to parse TV soccer programs. Object motion trajectories and interactions are used for football play classification and for soccer event detection. However, the prior art has traditionally relied on pre-extracted accurate object trajectories, which is done manually; hence, they are not practical for real-time applications. LucentVision and ESPN K-Zone track only specific objects for tennis and baseball, respectively, and they require complete control over camera positions for robust object tracking. Cinematic descriptors, which are applicable to broadcast video, are also commonly employed, e.g., the detection of plays and breaks in soccer games by frame view types and slow-motion replay detection using both cinematic and object descriptors. Scene cuts and camera motion parameters have been used for soccer event detection, although the use of very few cinematic features prevents reliable detection of multiple events. It has also been proposed to use the following: a mixture of cinematic and object descriptors, motion activity features for golf event detection, text information (e.g., from closed captions) and visual features, and audio features. However, none of those approaches has solved the problem of providing automatic, real-time soccer video analysis and summarization.

### SUMMARY OF THE INVENTION

It will be apparent from the above that a need exists in the art for an automatic, real-time technique for sports video analysis and summarization. It is therefore an object of the invention to provide such a technique.

It is another object of the invention to provide such a technique which uses cinematic and object features.

It is a further object of the invention to provide such a technique which is especially suited for soccer video analysis and summarization.

It is a still further object of the invention to provide such a technique which analyzes and summarizes soccer video information such that the semantically significant information can be sent over low-bandwidth connections, e.g., to a mobile telephone.

To achieve the above and other objects, the present invention is directed to a system and method for soccer video analysis implementing a fully automatic and computationally efficient framework for analysis and summarization of soccer videos using cinematic and object-based features. The proposed framework includes some novel low-level soccer video processing algorithms, such as dominant color region detection, robust shot boundary detection, and shot classification, as well as some higher-level algorithms for goal detection, referee detection, and penalty-box detection. The system can output three types of summaries: i) all slow-motion segments in a game, ii) all goals in a game, and iii) slow-motion segments classified according to object-based features. The first two types of summaries are based only on cinematic features for speedy processing, while the summaries of the last type contain higher-level semantics.

The system automatically extracts cinematic features, such as shot types and replay segments, and object-based features, such as the features to detect referee and penalty box objects. The system uses only cinematic features to generate real-time summaries of soccer games, and uses both cinematic and object-based features to generate near real-time, but more detailed, summaries of soccer games. Some of the algorithms are generic in nature and can be applied to other sports video. Such generic algorithms include dominant color region detection, which automatically learns the color of the play area (field region) and automatically adapts to field color variations due to change in imaging and environmental conditions, shot boundary detection, and shot classification. Novel soccer specific algorithms include goal event detection, referee detection and penalty box detection. The system also utilizes audio channel, text overlay detection and textual web commentary analysis. The result is that the system can, in real-time, summarize a soccer match and automatically compile a highlight summary of the match.

In addition to summarization and video processing system, we describe a new method of shot-type and event based video compression and bit allocation scheme, whereby spatial and temporal resolution of coded frames and allocated bits per frame (rate control) depend on the shot types and events. The new scheme is explained by the following steps:

Step 1: Sports video is segmented into shots (coherent temporal segments) and each shot is classified into one of the following three classes:

1. Long shots: Shots that show the global view of the field from a long distance.

2. Medium shots: The zoom-ins to specific parts of the field.

3. Close-up or other shots: The close shots of players, referee, coaches, and fans.

Step 2: For soccer videos, the new compression method allocates more of the bits to “long shots,” less bits to “medium shots,” and least bits to “other shots.” This is because players and the ball are small in long shots and small detail may be lost if enough bits are not allocated to these shots. Whereas characters in medium shots are relatively larger and are still visible in the presence of compression artifacts. Other shots are not vital to follow the action in the game. The exact allocation algorithm depends on the number of each type of shots in the sports summary to be delivered as well as the total available bitrate. For example, 60% of the bits can be allocated to long shots, while medium and other shots are allocated 25% and 15%, respectively.

For other sports video, such as basketball, football, tennis, etc., where there are significant stoppages in action, bit allocation can be more effectively done based on classification of shots to indicate “play” and “break” events. Play events refer to those when there is an action in the game, while breaks refer to stoppage times. Play and break events can be automatically determined based on sequencing of detected shot types. The new compression method then allocates most of the available bits to shots that belong to play events and encodes shots in the break events with the remaining bits.

We propose new dominant color region and shot boundary detection algorithms that are robust to variations in the dominant color. The color of the field may vary from stadium to stadium, and also as a function of the time of the day in the same stadium. Such variations are automatically captured at the initial supervised training stage of our proposed dominant color region detection algorithm. Variations during the game, due to shadows and/or lighting conditions, are also compensated by automatic adaptation to local statistics.

We propose two novel features for shot classification in soccer video for robustness to variations in cinematic features, which is due to slightly different cinematic styles used by different production crews. The proposed algorithm provides as high as 17.5% improvement over an existing algorithm.

We introduce new algorithms for automatic detection of i) goal events, ii) the referee, and iii) the penalty box in soccer videos. Goals are detected based solely on cinematic features resulting from common rules employed by the producers after goal events to provide a better visual experience for TV audiences. The distinguishing jersey color of the referee is used for fast and robust referee detection. Penalty box detection is based on the three-parallel-line rule that uniquely specifies the penalty box area in a soccer field.

Finally, we propose an efficient and effective framework for soccer video analysis and summarization that combines these algorithms in a scalable fashion. It is efficient in the sense that there is no need to compute object-based features when cinematic features are sufficient for the detection of certain events, e.g., goals in soccer. It is effective in the sense that the framework can utilize object-based features when needed to increase accuracy (at the expense of more computation). Hence, the proposed framework is adaptive to the requirements of the desired processing.

The present invention permits efficient compression of sports video for low-bandwidth channels, such as wireless and low-speed Internet connections. The invention makes it possible to deliver sports video or sports video highlights (summaries) at bitrates as low as 16 kbps at a frame resolution of 176×144. The method also enhances visual quality of sports video for channels with bitrates up to 350 kbps.

The invention has the following particular uses, which are illustrative rather than limiting:

Digital Video Recording: The system allows an individual, who is pressed for time, to view only the highlights of a soccer g ame recorded with a digital video recorder. The system would also enable an individual to watch one program and be notified of when an important highlight has occurred in the soccer game being recorded so that the individual may switch over to the soccer game to watch the event.

Telecommunications: The system enables live streaming of a soccer game summary over both wide- and narrow-band networks, such as PDA's, cell phones, and the Internet. Therefore, fans who wish to follow their favorite team while away from home can not only get up-to-the-moment textual updates on the status of the game, but also they are able to view important highlights of the game such as a goal scoring event.

Television Editing: Due to the real-time nature of the system, the system provides an excellent alternative to current laborious manual video editing for TV broadcasting.

Sports Databases: The system can also be used to automatically extract video segment, object, and event descriptions in MPEG-7 format thereby enabling the creation of large sports databases in a standardized format which can be used for training and coaching sessions.

### BRIEF DESCRIPTION OF THE DRAWINGS

A preferred embodiment of the present invention will be set forth in detail with reference to the drawings, in which:

FIG. 1 shows a high-level flowchart of the operation of the preferred embodiment;

FIG. 2 shows a flowchart for the detection of a dominant color region in the preferred embodiment;

FIG. 3 shows a flowchart for shot boundary detection in the preferred embodiment;

FIGS. 4A-4F show various kinds of shots in soccer videos;

FIGS. 5A-5F show a section decomposition technique for distinguishing the various kinds of soccer shots of FIGS. 4A-4F;

FIG. 6 shows a flowchart for distinguishing the various kinds of soccer shots of FIGS. 4A-4F using the technique of FIGS. 5A-5F;

FIGS. 7A-7F show frames from the broadcast of a goal;

FIG. 8 shows a flowchart of a technique for detection of the goal;

FIGS. 9A-9D show stages in the identification of a referee;

FIG. 10 shows a flowchart of the operations of FIGS. 9A-9D;

FIG. 11A shows a diagram of a soccer field;

FIG. 11B shows a portion of FIG. 11A with the lines defining the penalty box identified;

FIGS. 12A-12F show stages in the identification of the penalty box;

FIG. 13 shows a flowchart of the operations of FIGS. 12A-12F; and

FIG. 14 shows a schematic diagram of a system on which the preferred embodiment can be implemented.

### DETAILED DESCRIPTION OF THE PREFERRED EMBODIMENT

The preferred embodiment will now be described in detail with reference to the drawings.

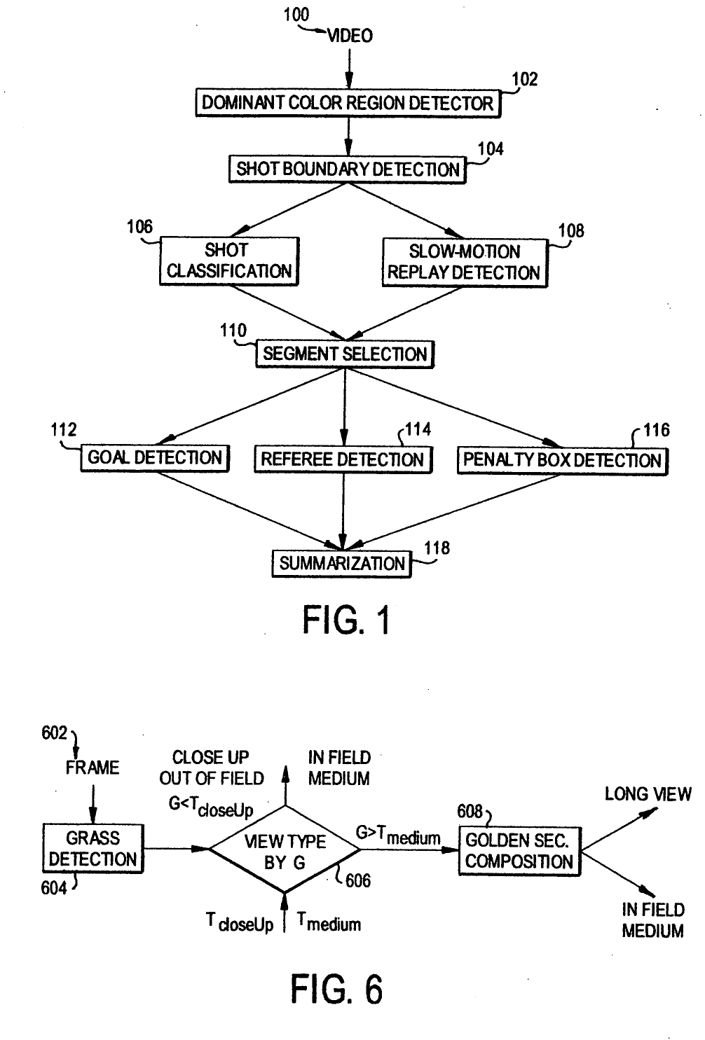

FIG. 1 shows a high-level flowchart of the operation of the preferred embodiment. The various steps shown in FIG. 1 will be explained in detail below.

A raw video feed 100 is received and subjected to dominant color region detection in step 102. Dominant color region detection is performed because a soccer field has a distinct dominant color (typically a shade of green) which may vary from stadium to stadium. The video feed is then subjected to shot boundary detection in step 104. While shot boundary detection in general is known in the art, an improved technique will be explained below.

Shot classification and slow-motion replay detection are performed in steps 106 and 108, respectively. Then, a segment of the video is selected in step 110, and the goal, referee and penalty box are detected in steps 112, 114 and 116, respectively. Finally, in step 118, the video is summarized in accordance with the detected goal, referee and penalty box and the detected slow-motion replay.

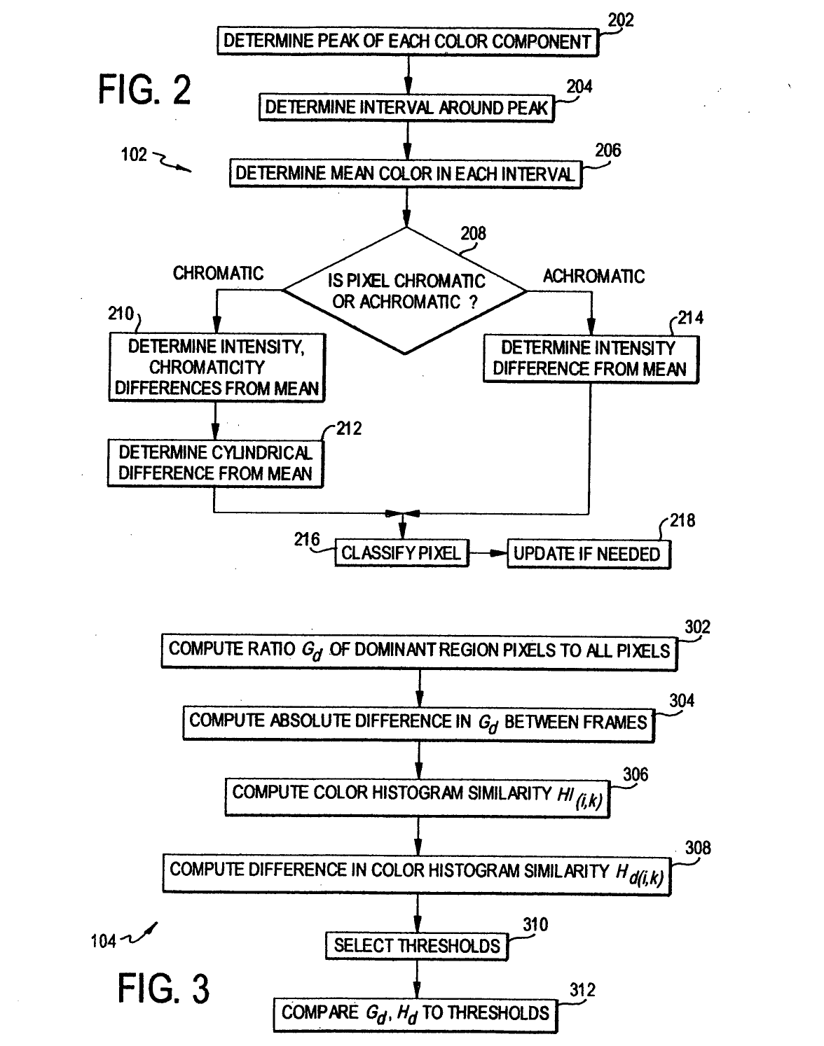

The dominant color region detection of step 102 will be explained with reference to FIG. 2. A soccer field has one distinct dominant color (a tone of green) that may vary from stadium to stadium, and also due to weather and lighting conditions within the same stadium. Therefore, the algorithm does not assume any specific value for the dominant color of the field, but learns the statistics of this dominant color at start-up, and automatically updates it to adapt to temporal variations.

The dominant field color is described by the mean value of each color component, which are computed about their respective histogram peaks. The computation involves determination in step 202 of the peak index, iₚₑₐₖ, for each histogram, which may be obtained from one or more frames. Then, an interval, [iₘᵢₙ, iₘₐₓ], about each peak is defined in step 204, where iₘᵢₙ and iₘₐₓ refer to the minimum and maximum of the interval, respectively, that satisfy the conditions in Eqs. 1-3 below, where H refers to the color histogram. The conditions define the minimum (maximum) index as the smallest (largest) index to the left (right) of, including, the peak that has a predefined number of pixels. In our implementation, we fixed this minimum number as 20% of the peak count, i.e., K=0.2. Finally, the mean color in the detected interval is computed in step 206 for each color component.

H[iₘᵢₙ]≧K*H[iₚₑₐₖ] and H[iₘᵢₙ−1]<K*H[iₚₑₐₖ] (1)

H[iₘₐₓ]≧K*H[iₚₑₐₖ] and H[iₘₐₓ+1]<K*H[iₚₑₐₖ] (2)

iₘᵢₙ≦iₚₑₐₖ and iₘₐₓ≧iₚₑₐₖ (3)

Field colored pixels in each frame are detected by finding the distance of each pixel to the mean color by the robust cylindrical metric or another appropriate metric, such as Euclidean distance, for the selected color space. Since we used the HSI (hue-saturation-intensity) color space in our experiments, achromaticity in this space must be handled with care. If it is determined in step 208 that the estimated saturation and intensity means for a pixel fall in the achromatic region, only intensity distance in Eq. 4 is computed in step 214 for achromatic pixels. Otherwise, both Eq. 4 and Eq. 5 are employed for chromatic pixels in each frame in steps 210 and 212. Then, the pixel is classified as belonging to the dominant color region or not in step 216.

d_{intensity}(j)=|Iⱼ−Iₘₑₐₙ| (4)

d_{cylindrical}(j)=\sqrt{(Sⱼ)²+(Sₘₑₐₙ)²−2SⱼSₘₑₐₙ cos (θ)} (5)

d_{cylindrical}(j)=\sqrt{(d_{intensity})²+(d_{chromaticity})²} (6)

$$θ = \{ \begin{matrix}\vert H {ue}_{mean} - H {ue}_{j} \vert & if \vert H {ue}_{mean} - H {ue}_{j} \vert < {180}^{°} \\ {360}^{°} - \vert H {ue}_{mean} - H {ue}_{j} \vert & if \vert H {ue}_{mean} - H {ue}_{j} \vert > {180}^{°}\end{matrix} \qquad ( 7 )$$

In the equations, Hue, S, and I refer to hue, saturation and intensity, respectively, j is the j^{th} pixel, and θ is defined in Eq. 7. The field region is defined as those pixels having d_{cylindrical}<T_{color}, where T_{color} is a pre-defined threshold value that is determined by the algorithm given the rough percentage of dominant colored pixels in the training segment. The adaptation to the temporal variations is achieved by collecting color statistics of each pixel that has d_{cylindrical} smaller than a*T_{color}, where a>1.0. That means, in addition to the field pixels, the close non-field pixels are included to the field histogram computation. When the system needs an update, the collected statistics are used in step 218 to estimate the new mean color value is computed for each color component.

An alternative is to use more than one color space for dominant color region detection. The process of FIG. 2 is modified accordingly.

The shot boundary detection of step 104 will now be described with reference to FIG. 3. Shot boundary detection is usually the first step in generic video processing. Although it has a long research history, it is not a completely solved problem. Sports video is arguably one of the most challenging domains for robust shot boundary detection due to the following observations: 1) There is strong color correlation between sports video shots that usually does not occur in generic video. The reason for this is the possible existence of a single dominant color background, such as the soccer field, in successive shots. Hence, a shot change may not result in a significant difference in the frame histograms. 2) Sports video is characterized by large camera and object motions. Thus, shot boundary detectors that use change detection statistics are not suitable. 3) A sports video contains both cuts and gradual transitions, such as wipes and dissolves. Therefore, reliable detection of all types of shot boundaries is essential.

In the proposed algorithm, we take the first observation into account by introducing a new feature, the absolute difference of the ratio of dominant colored pixels to total number of pixels between two frames denoted by G_{d}. Computation of G_{d} between the i^{th} and (i−k)^{th} frames in step 302 is given by Eq. 8, where Gᵢ represents the grass colored pixel ratio in the i^{th} frame. The absolute difference of G_{d} between frames is calculated in step 304.

As the second feature, we use the difference in color histogram similarity, H_{d}, which is computed by Eq. 9. The similarity between two histograms is measured in step 306 by histogram intersection in Eq. 10, where the similarity between the i^{th} and (i−k)^{th} frames, HI (i, k), is computed. In the same equation, N denotes the number of color components, and is three in our case, Bₘ is the number of bins in the histogram of the m^{th} color component, and Hᵢ^{m} is the normalized histogram of the i^{th} frame for the same color component. Then Eq. 9 is carried out in step 308.

The algorithm uses different k values in Eqs. 8-10 to detect cuts and gradual transitions. Since cuts are instant transitions, k=1 will detect cuts, and other values will indicate gradual transitions.

G_{d}(i, k)=|Gᵢ−Gᵢ₋ₖ| (8)

H_{d}(i, k) |HI(i, k)−HI(i−k, k)| (9)

$$HI ( i , k ) = \frac{1}{N} {\sum }_{m = 1}^{N} {\sum }_{j = 0}^{{B}_{m} - 1} min ( {H}_{i}^{m} [ j ] , {H}_{i - k}^{m} [ j ] ) \qquad ( 10 )$$

A shot boundary is determined by comparing H_{d} and G_{d} with a set of thresholds. A novel feature of the proposed method, in addition to the introduction of G_{d} as a new feature, is the adaptive change of the thresholds on H_{d}. When a sports video shot corresponds to out-of-field or close-up views, the number of field colored pixels will be very low and the shot properties will be similar to a generic video shot. In such cases, the problem is the same as generic shot boundary detection; hence, we use only H_{d} with a high threshold. In the situations where the field is visible, we use both H_{d} and G_{d}, but using a lower threshold for H_{d}. Thus, we define four thresholds for shot boundary detection: T_{H}^{Low}, T_{H}^{High}, T_{G}, and T_{lowgrass}. The first two thresholds are the low and high thresholds for H_{d}, and T_{G} is the threshold for G_{d}. The last threshold is essentially a rough estimate for low grass ratio, and determines when the conditions change from field view to non-field view. The values for these thresholds is set for each sport type after a learning stage. Once the thresholds are set, the algorithm needs only to compute local statistics and runs in real-time by selecting the thresholds in step 312 and comparing the values of G_{d} and H_{d} to the thresholds in step 312. Furthermore, the proposed algorithm is robust to spatial downsampling, since both G_{d} and H_{d} are size-invariant.

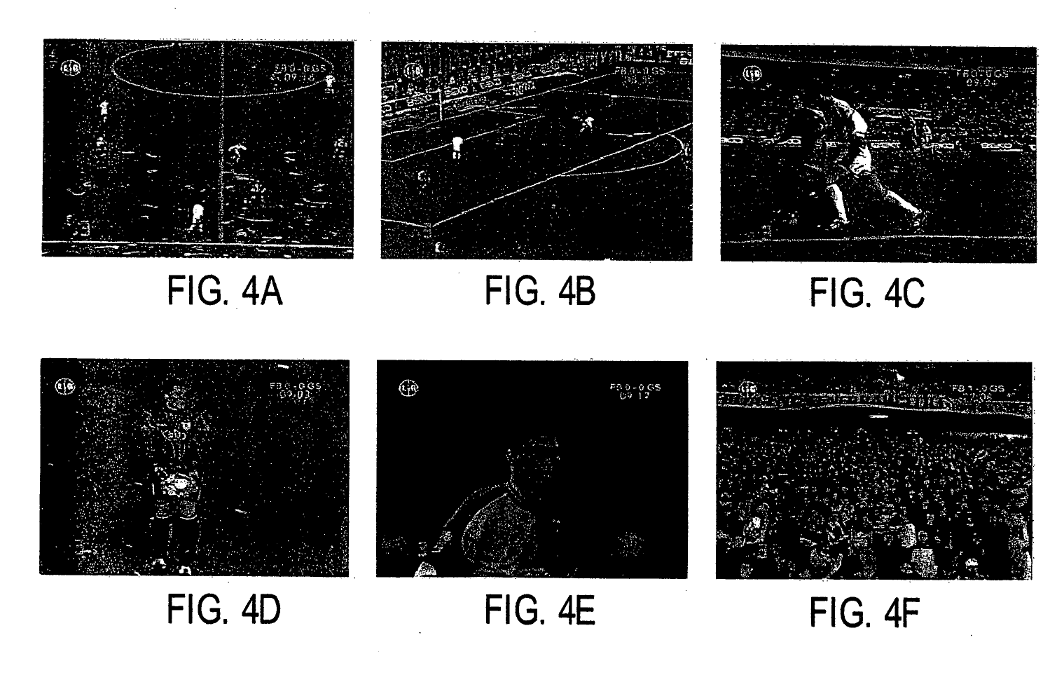

The shot classification of step 106 will now be explained with reference to FIGS. 4A-4F, 5A-5F and 6. The type of a shot conveys interesting semantic cues; hence, we classify soccer shots into three classes: 1) Long shots, 2) In-field medium shots, and 3) Out-of-field or close-up shots. The definitions and characteristics of each class are given below:

Long shot: A long shot displays the global view of the field as shown in FIGS. 4A and 4B; hence, a long shot serves for accurate localization of the events on the field.

In-field medium shot (also called medium shot): A medium shot, where a whole human body is usually visible, is a zoomed-in view of a specific part of the field as in FIGS. 4C and 4D.

Close-up or Out-of-field Shot: A close-up shot usually shows above-waist view of one person, as in FIG. 4E. The audience, coach, and other shots are denoted as out-of-field shots, as in FIG. 4F. Long views are shown in FIGS. 4A and 4B, while medium views are shown in FIGS. 4C and 4D. We analyze both out of field and close-up shots in the same category due to their similar semantic meaning.

Classification of a shot into one of the above three classes is based on spatial features. Therefore, shot class can be determined from a single key frame or from a set of frames selected according to a certain criteria. In order to find the frame view, the frame grass colored pixel ratio, G, is computed. In the prior art, an intuitive approach has been used, where a low G value in a frame corresponds to a non-field view, while a high G value indicates a long view, and in between, a medium view is selected. Although the accuracy of that approach is sufficient for a simple play-break application, it is not sufficient for extraction of higher level semantics. By using only a grass colored pixel ratio, medium shots with a high G value will be mislabeled as long shots. The error rate due to this approach depends on the broadcasting style and it usually reaches intolerable levels for the employment of higher level algorithms to be described below. Therefore, another feature is necessary for accurate classification of the frames with a high number of grass colored pixels.

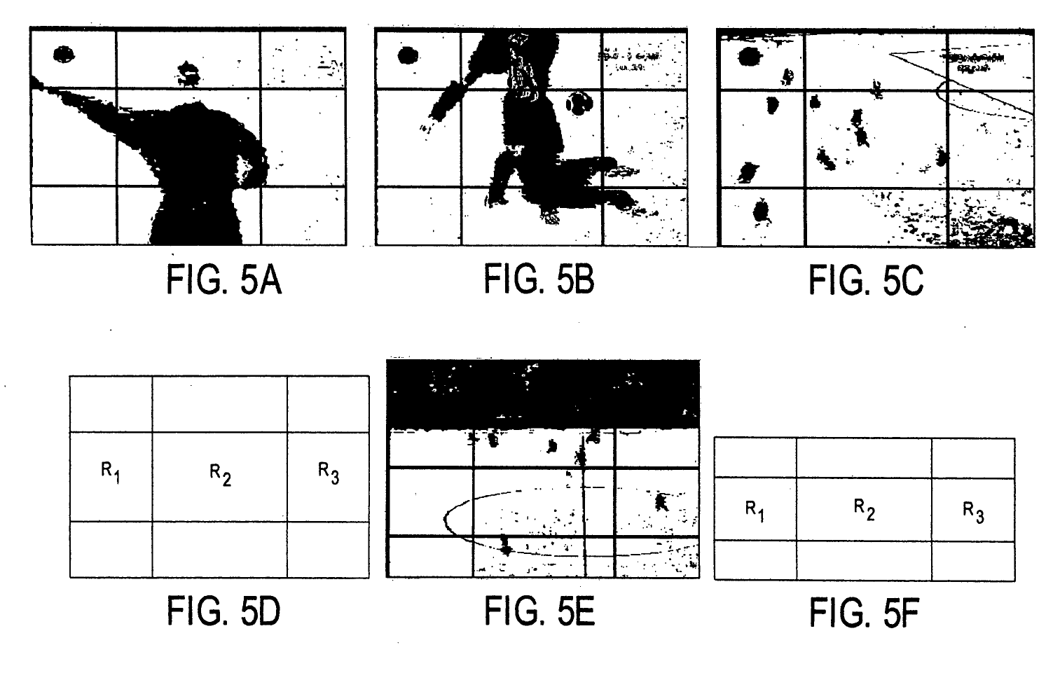

We propose a computationally easy, yet efficient cinematographic measure for the frames with high G values. We define regions by using the Golden Section spatial composition rule, which suggests dividing up the screen in 3:5:3 proportion in both directions, and positioning the main subjects on the intersection of these lines. We have revised this rule for soccer video, and divide the grass region box instead of the whole frame. The grass region box can be defined as the minimum bounding rectangle (MBR), or a scaled version of it, of grass colored pixels. In FIGS. 5A-5F, the examples of the regions obtained by Golden Section rule are displayed on several medium and long views. FIGS. 5A and 5B show medium views, while FIGS. 5C and 5E show long views. In the regions R₁, R₂ and R₃ in FIGS. 5D (corresponding to FIGS. 5A-5C) and 5F (corresponding to FIG. 5E), we found the two features below the most distinguishing: G_{R}_{₂}, the grass colored pixel ratio in the second region, and R_{diff}, the average of the sum of the absolute grass color pixel differences between R₁ and R₂, and between R₂ and R₃, found by

$${R}_{diff} = \frac{1}{2} \{ \vert {G}_{{R}_{1}} - {G}_{{R}_{2}} \vert + \vert {G}_{{R}_{2}} - {G}_{{R}_{3}} \vert \} .$$

Then, we employ a Bayesian classifier using the above two features.

The flowchart of the proposed shot classification algorithm is shown in FIG. 6. A frame is input in step 602, and the grass is detected in step 604 through the techniques described above. The first stage, in step 606, uses the G value and two thresholds, T_{closeup} and T_{medium}, to determine the frame view label. These two thresholds are roughly initialized to 0.1 and 0.4 at the start of the system, and as the system collects more data, they are updated to the minimum of the histogram of the grass colored pixel ratio, G. When G>T_{medium}, the algorithm determines the frame view in step 608 by using the golden section composition described above.

The slow-motion replay detection of step 108 is known in the prior art and will therefore not be described in detail here.

Detection of certain events and objects in a soccer game enables generation of more concise and semantically rich summaries. Since goals are arguably the most significant event in soccer, we propose a novel goal detection algorithm. The proposed goal detector employs only cinematic features and runs in real-time. Goals, however, are not the only interesting events in a soccer game. Controversial decisions, such as red-yellow cards and penalties (medium and close-up shots involving referees), and plays inside the penalty box, such as shots and saves, are also important for summarization and browsing. Therefore, we also develop novel algorithms for referee and penalty box detection.

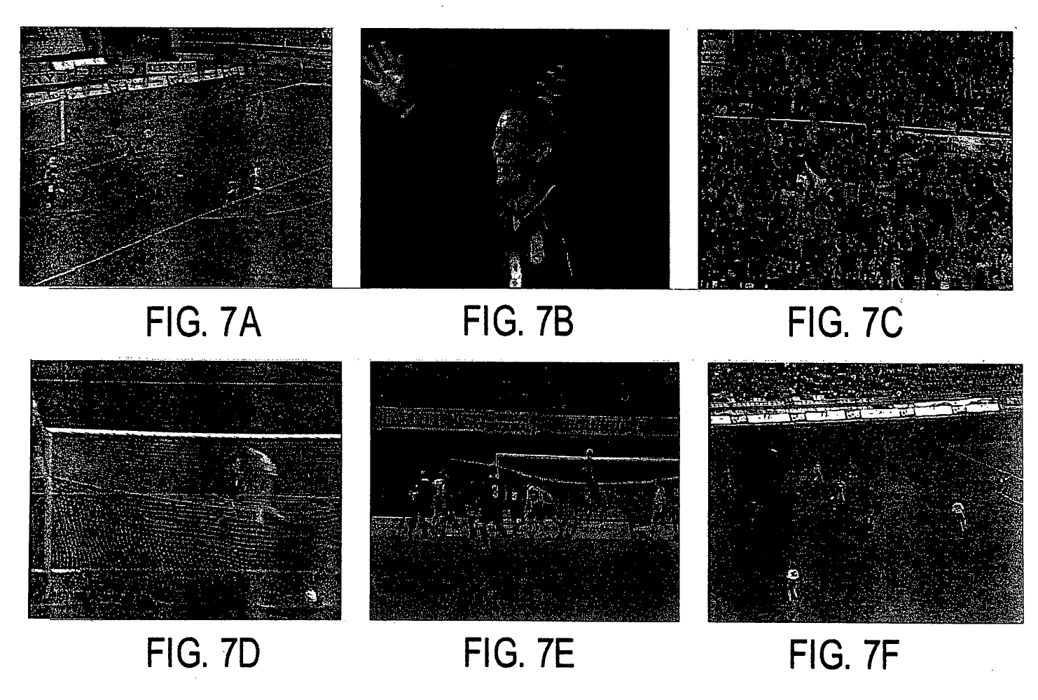

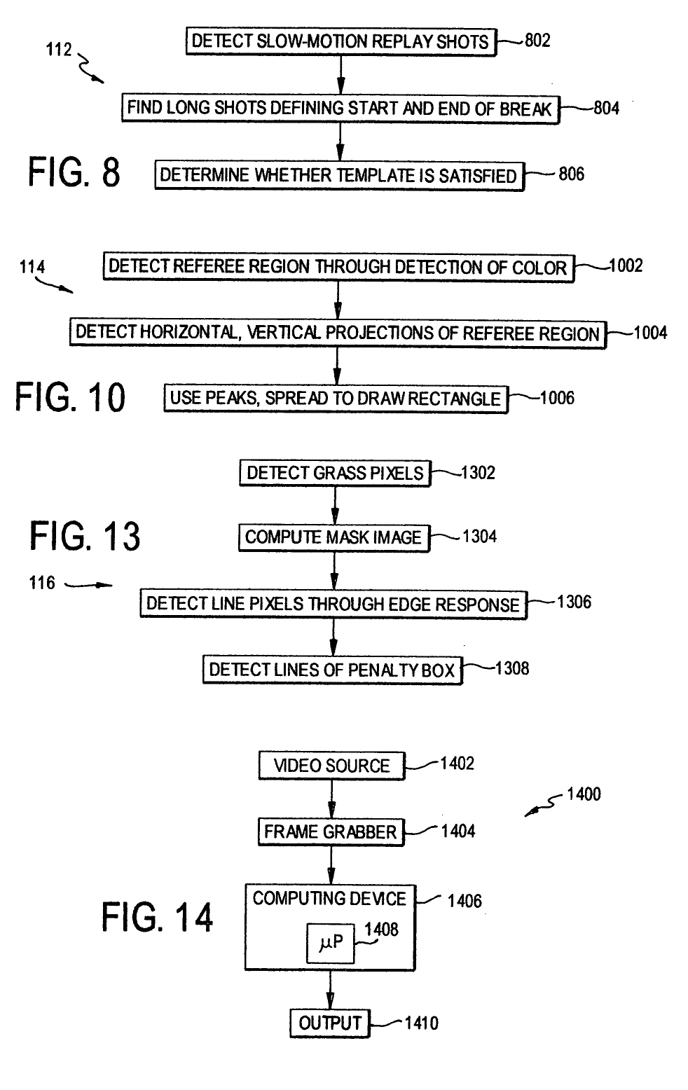

The goal detection of FIG. 1, step 112, will now be explained with reference to FIGS. 7A-7F and 8. A goal is scored when the whole of the ball passes over the goal line, between the goal posts and under the crossbar. Unfortunately, it is difficult to verify these conditions automatically and reliably by video processing algorithms. However, the occurrence of a goal is generally followed by a special pattern of cinematic features, which is what we exploit in our proposed goal detection algorithm. A goal event leads to a break in the game. During this break, the producers convey the emotions on the field to the TV audience and show one or more replay(s) for a better visual experience. The emotions are captured by one or more close-up views of the actors of the goal event, such as the scorer and the goalie, and by frames of the audience celebrating the goal. For a better visual experience, several slow-motion replays of the goal event from different camera positions are shown. Then, the restart of the game is usually captured by a long shot. Between the long shot resulting in the goal event and the long shot that shows the restart of the game, we define a cinematic template that should satisfy the following requirements:

Duration of the break: A break due to a goal lasts no less than 30 and no more than 120 seconds.

The occurrence of at least one close-up/out-of-field shot: This shot may either be a close-up of a player or out-of-field view of the audience.

The existence of at least one slow-motion replay shot: The goal play is always replayed one or more times.

The relative position of the replay shot: The replay shot(s) follow the close-up/out-of-field shot(s).

In FIGS. 7A-7F, the instantiation of the template is demonstrated for the first goal in a sequence of an MPEG-7 data set, where the break lasts for 54 sec. More specifically, FIGS. 7A-7F show, respectively, a long view of the actual goal play, a player close-up, the audience, the first replay, the third replay and a long view of the start of the new play.

The search for goal event templates start by detection of the slow-motion replay shots (FIG. 1, step 108; FIG. 8, step 802). For every slow-motion replay shot, we find in step 804 the long shots that define the start and the end of the corresponding break. These long shots must indicate a play that is determined by a simple duration constraint, i.e., long shots of short duration are discarded as breaks. Finally, in step 806, the conditions of the template are verified to detect goals. The proposed “cinematic template” models goal events very well, and the detection runs in real-time with a very high recall rate.

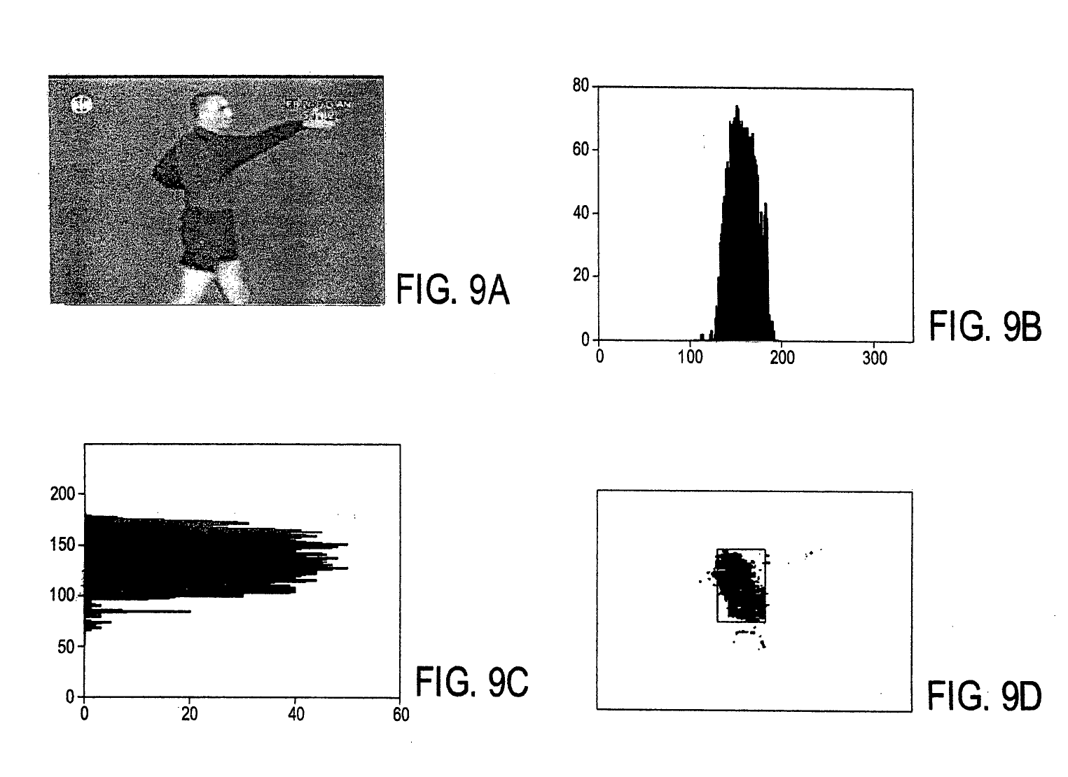

The referee detection of FIG. 1, step 114, will now be described with reference to FIGS. 9A-9D and 10. Referees in soccer games wear distinguishable colored uniforms from those of the two teams on the field. Therefore, a variation of the dominant color region detection algorithm of FIG. 2 can be used in FIG. 10, step 1002, to detect referee regions. We assume that there is, if any, a single referee in a medium or out-of-field/close-up shot (we do not search for a referee in a long shot). Then, the horizontal and vertical projections of the feature pixels can be used in step 1004 to accurately locate the referee region. The peak of the horizontal and the vertical projections and the spread around the peaks are used in step 1004 to compute the rectangle parameters of a minimum bounding rectangle (MBR) surrounding the referee region, hereinafter MBR_{ref}. The coordinates of MBR_{ref} are defined to be the first projection coordinates at both sides of the peak index without enough pixels, which is assumed to be 20% of the peak projection. FIGS. 9A-9D show, respectively, the referee pixels in an example frame, the horizontal and vertical projections of the referee region, and the resulting referee MBR_{ref}.

The decision about the existence of the referee in the current frame is based on the following size-invariant shape descriptors:

The ratio of the area of MBR_{ref} to the frame area: A low value indicates that the current frame does not contain a referee.

MBR_{ref} aspect ratio (width/height): That ratio determines whether the MBR_{ref} corresponds to a human region.

Feature pixel ratio in MBR_{ref}: This feature approximates the compactness of MBR_{ref}, higher compactness values are favored.

The ratio of the number of feature pixels in MBR_{ref} to that of the outside: It measures the correctness of the single referee assumption. When this ratio is low, the single referee assumption does not hold, and the frame is discarded.

The proposed approach for referee detection runs very fast, and it is robust to spatial downsampling. We have obtained comparable results for original (352×240 or 352×288), and for 2×2 and 4×4 spatially downsampled frames.

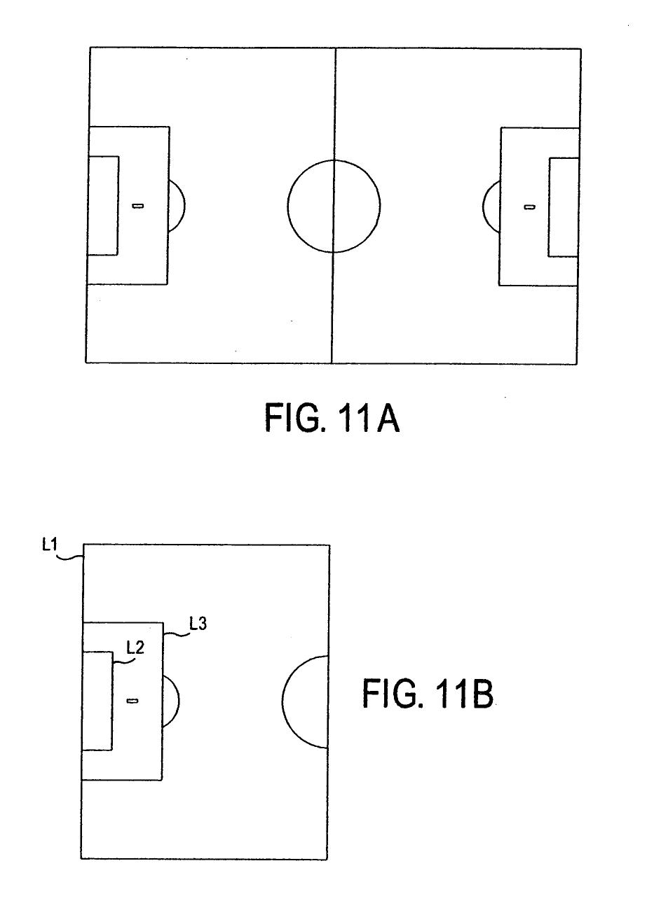

The penalty box detection of FIG. 1, step 116, will now be explained with reference to FIGS. 11A-11B, 12A-12F and 13. Field lines in a long view can be used to localize the view and/or register the current frame on the standard field model. In this section, we reduce the penalty box detection problem to the search for three parallel lines. In FIG. 11A, a view of the whole soccer field is shown, and three parallel field lines, shown in FIG. 11B as L1, L2 and L3, become visible when the action occurs around one of the penalty boxes. This observation yields a robust method for penalty box detection, and it is arguably more accurate than the goal post detection of the prior art for a similar analysis, since goal post views are likely to include cluttered background pixels that cause problems for Hough transform.

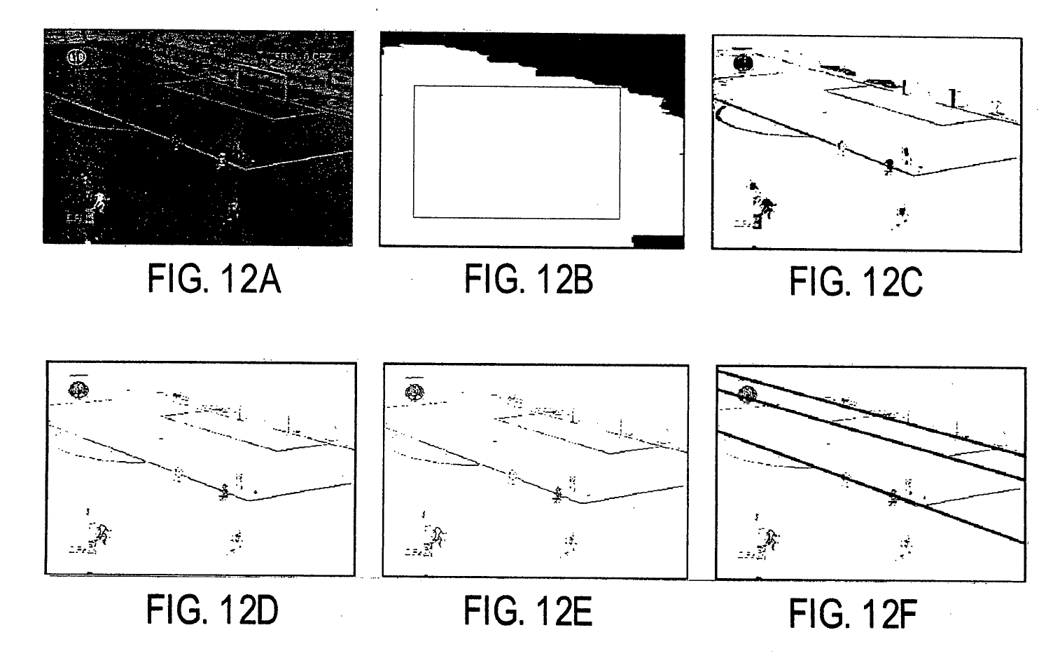

To detect three lines, we use the grass detection result described above with reference to FIG. 2, as shown in FIG. 13, step 1302. An input frame is shown in FIG. 12A. To limit the operating region to the field pixels, we compute a mask image from the grass colored pixels, displayed in FIG. 12B, as shown in FIG. 13, step 1304. The mask is obtained by first computing a scaled version of the grass MBR, drawn on the same figure, and then, by including all field regions that have enough pixels inside the computed rectangle. As shown in FIG. 12C, non-grass pixels may be due to lines and players in the field. To detect line pixels, we use edge response in step 1306, defined as the pixel response to the 3×3 Laplacian mask in Eq. 11. The pixels with the highest edge response, the threshold of which is automatically determined from the histogram of the gradient magnitudes, are defined as line pixels. The resulting line pixels after the Laplacian mask operation and the image after thinning are shown in FIGS. 12D and 12E, respectively.

$$h = [ \begin{matrix}1 & 1 & 1 \\ 1 & - 8 & 1 \\ 1 & 1 & 1\end{matrix} ] \qquad ( 11 )$$

Then, three parallel lines are detected in step 1308 by a Hough transform that employs size, distance and parallelism constraints. As shown in FIG. 11B, the line L2 in the middle is the shortest line, and it has a shorter distance to the goal line L1 (outer line) than to the penalty line L3 (inner line). The detected three lines of the penalty box in FIG. 12A are shown in FIG. 12F.

The present invention may be implemented on any suitable hardware. An illustrative example will be set forth with reference to FIG. 14. The system 1400 receives the video signal through a video source 1402, which can receive a live feed, a videotape or the like. A frame grabber 1404 converts the video signal, if needed, into a suitable format for processing. Frame grabbers for converting, e.g., NTSC signals into digital signals are known in the art. A computing device 1406, which includes a processor 1408 and other suitable hardware, performs the processing described above. The result is sent to an output 1410, which can be a recorder, a transmitter or any other suitable output.

Results will now be described. We have rigorously tested the proposed algorithms over a data set of more than 13 hours of soccer video. The database is composed of 17 MPEG-1 clips, 16 of which are in 352×240 resolution at 30 fps and one in 352×288 resolution at 25 fps. We have used several short clips from two of the 17 sequences for training. The segments used for training are omitted from the test set; hence, neither sequence is used by the goal detector.

In this section, we present the performance of the proposed low-level algorithms. We define two ground truth sets, one for shot boundary detector and shot classifier, and one for slow-motion replay detector. The first set is obtained from three soccer games captured by Turkish, Korean, and Spanish crews, and it contains 49 minutes of video. The sequences are not chosen arbitrarily; on the contrary, we intentionally selected the sequences from different countries to demonstrate the robustness of the proposed algorithms to varying cinematic styles.

Each frame in the first set is downsampled, without low-pass filtering, by a rate of four in both directions to satisfy the real-time constraints, that is, 88×60 or 88×72 is the actual frame resolution for shot boundary detector and shot classifier. Overall, the algorithm achieves 97.3% recall and 91.7% precision rates for cut-type boundaries. On the same set at full resolution, a generic cut-detector, which comfortably generates high recall and precision rates (greater than 95%) for non-sports video, has resulted in 75.6% recall and 96.8% precision rates. A generic algorithm, as expected, misses many shot boundaries due to the strong color correlation between sports video shots. The precision rate at the resulting recall value does not have a practical use. The proposed algorithm also reliably detects gradual transitions, which refer to wipes for Turkish, wipes and dissolves for Spanish, and other editing effects for Korean sequences. On the average, the algorithm achieves 85.3% recall and 86.6% precision rates. Gradual transitions are difficult, if not impossible, to detect when they occur between two long shots or between a long and a medium shot with a high grass ratio.

The accuracy of the shot classification algorithm, which uses the same 88×60 or 88×72 frames as shot boundary detector, is shown in Table 1 below, in which results using only the grass measure are in columns marked G and in which results using the method according to the preferred embodiment are in columns marked P. For each sequence, we provide two results, one by using only grass colored pixel ratio, G, and the other by using both G and the proposed features, G_{R}_{₂} and R_{diff}. Our results for the Korean and Spanish sequences by using only G are very close to the conventional results on the same set. By introducing two new features, G_{R}_{₂}, and R_{diff}, we are able to obtain 17.5%, 6.3%, and 13.8% improvement in the Turkish, Korean, and Spanish sequences, respectively. The results clearly indicate the effectiveness and the robustness of the proposed algorithm for different cinematographic styles.

TABLE 1

| | Sequence | | | | | | | |
|---|---|---|---|---|---|---|---|---|
| | Turkish | | Korean | | Spanish | | | All |
| | Method | | | | | | | |
| | G | P | G | P | G | P | G | P |
| # of Shots | 188 | 188 | 128 | 128 | 58 | 58 | 374 | 374 |
| Correct | 131 | 164 | 106 | 114 | 47 | 55 | 284 | 333 |
| False | 57 | 24 | 22 | 14 | 11 | 3 | 90 | 41 |
| Accuracy(%) | 69.7 | 87.2 | 82.8 | 89.1 | 81.0 | 94.8 | 75.9 | 89.0 |

The ground truth for slow-motion replays includes two new sequences making the length of the set 93 minutes, which is approximately equal to a complete soccer game. The slow-motion detector uses frames at full resolution and has detected 52 of 65 replay shots, 80.0% recall rate, and incorrectly labeled 9 normal motion shots, 85.2% precision rate, as replays. Overall, the recall-precision rates in slow-motion detection are quite satisfactory.

Goals are detected in 15 test sequences in the database. Each sequence, in full length, is processed to locate shot boundaries, shot types, and replays. When a replay is found, goal detector computes the cinematic template features to find goals. The proposed algorithm runs in real-time, and, on the average, achieves 90.0% recall and 45.8% precision rates. We believe that the three misses out of 30 goals are more important than false positives, since the user can always fast-forward false positives, which also do have semantic importance due to the replays. Two of the misses are due to the inaccuracies in the extracted shot-based features, and the miss where the replay shot is broadcast minutes after the goal is due to the deviation from the goal model. The false alarm rate is directly related to the frequency of the breaks in the game. The frequent breaks due to fouls, throw-ins, offsides, etc. with one or more slow-motion shots may generate cinematic templates similar to that of a goal. The inaccuracies in shot boundaries, shot types, and replay labels also contribute to the false alarm rate.

We have explained above that the existence of referee and penalty box in a summary segment, which, by definition, also contains a slow-motion shot, may correspond to certain events. Then, the user can browse summaries by these object-based features. The recall rate of and the confidence with referee and penalty box detection are specified for a set of semantic events in Tables 2 and 3 below, where recall rate measures the accuracy of the proposed algorithms, and the confidence value is defined as the ratio of the number of events with that object to the the total number of such events in the clips, and it indicates the applicability of the corresponding object-based feature to browsing a certain event. For example, the confidence of observing a referee in a free kick event is 62.5%, meaning that the referee feature may not be useful for browsing free kicks. On the other hand, the existence of both objects is necessary for a penalty event due to their high confidence values. In Tables 2 and 3, the first row shows the total number of a specific event in the summaries. Then, the second row shows the number of events where the referee and/or the three penalty box lines are visible. In the third row, the number of detected events is given. Recall rates in the second columns of both Tables 2 and 3 are lower than those of other events. For the former, the misses are due to referee's occlusion by other players, and for the latter, abrupt camera movement during a high activity prevents reliable penalty box detection. Finally, it should be noted that the proposed features and their statistics are used for browsing purposes, not for detecting such non-goal events; hence, precision rates are not meaningful.

TABLE 2

| | Yellow/Red Cards | Penalties | Free-Kicks |
|---|---|---|---|
| Total | 19 | 3 | 8 |
| Referee | 19 | 3 | 5 |
| Appears | | | |
| Detected | 16 | 3 | 5 |
| Recall(%) | 84.2 | 100 | 100 |
| Confidence(%) | 100 | 100 | 62.5 |

TABLE 3

| | Shots/Saves | Penalties | Free-Kicks |
|---|---|---|---|
| Total | 50 | 3 | 8 |
| Penalty Box | 49 | 3 | 8 |
| Appears | | | |
| Detected | 41 | 3 | 8 |
| Recall(%) | 83.7 | 100 | 100 |
| Confidence(%) | 98.0 | 100 | 100 |

The compression rate for the summaries varies with the requested format. On the average, 12.78% of a game is included to the summaries of all slow-motion segments, while the summaries consisting of all goals, including all false positives, only account for 4.68%, of a complete soccer game. These rates correspond to the summaries that are less than 12 and 5 minutes, respectively, of an approximately 90-minute game.

The RGB to HSI color transformation required by grass detection limits the maximum frame size; hence, 4×4 spatial downsampling rates for both shot boundary detection and shot classification algorithms are employed to satisfy the real-time constraints. The accuracy of the slow-motion detection algorithm is sensitive to frame size; therefore, no sampling is employed for this algorithm, yet the computation is completed in real-time with a 1.6 GHz CPU speed. A commercial system can be implemented by multi-threading where shot boundary detection, shot classification, and slow-motion detection should run in parallel. It is also affordable to implement the first two sequentially, as it was done in our system. In addition to spatial sampling, temporal sampling may also be applied for shot classification without significant performance degradation. In this framework, goals are detected with a delay that is equal to the cinematic template length, which may range from 30 to 120 seconds.

A new framework for summarization of soccer video has been introduced. The proposed framework allows real-time event detection by cinematic features, and further filtering of slow-motion replay shots by object based features for semantic labeling. The implications of the proposed system include real-time streaming of live game summaries, summarization and presentation according to user preferences, and efficient semantic browsing through the summaries, each of which makes the system highly desirable.

While a preferred embodiment has been set forth above, those skilled in the art who have reviewed the present disclosure will readily appreciate that other embodiments can be realized within the scope of the present invention. For example, numerical examples are illustrative rather than limiting. Also, as noted above, the present invention has utility to sports other than soccer. Therefore, the present invention should be construed as limited only by the appended claims.

We claim:

1. A method for analyzing a sports video sequence, the method comprising:
(a) detecting a dominant color region in the video sequence;
(b) detecting boundaries of shots in the video sequence in accordance with color data in the video sequence;
(c) classifying at least one of the shots whose boundaries have been detected in step (b) through spatial composition of the dominant color region;
(d) detecting at least one of a goal event, a person and a location in the video sequence; and
(e) analyzing and summarizing the sports video sequence in accordance with a result of step (d).

2. The method of claim 1, wherein step (a) is performed with respect to a plurality of color spaces.

3. The method of claim 1, wherein step (a) comprises:
(i) determining a peak of each color component;
(ii) determining an interval around each peak determined in step (a)(i);
(iii) determining a mean color in each interval determined in step (a)(ii); and
(iv) classifying each pixel in the video sequence as belonging to the dominant color region or as not belonging to the dominant color region in accordance to the mean color in each interval determined in step (a)(iii).

4. The method of claim 3, wherein step (a)(iv) comprises determining a distance in color space between each pixel and the mean color.

5. The method of claim 3, wherein step (a) is performed a plurality of times through the video sequence.

6. The method of claim 1, wherein step (b) comprises determining whether a first frame and a second frame are in a same shot or in different shots by:
(i) determining, for each of the first frame and the second frame, a ratio of pixels in the dominant color region to all pixels;
(ii) determining a difference between the ratio determined for the first frame and the ratio determined for the second frame; and
(iii) comparing the difference determined in step (b)(ii) to a first threshold value.

7. The method of claim 6, wherein step (b) further comprises:
(iv) computing a histogram intersection for the first frame and the second frame;
(v) computing a difference in color histogram similarity for the first frame and the second frame in accordance with the histogram intersection; and
(vi) comparing the difference in color histogram similarity to a second threshold value

8. The method of claim 7, wherein the second threshold value is selected in accordance with a type of shot whose boundaries are to be detected.

9. The method of claim 1, wherein step (c) comprises:
(i) calculating a ratio of a number of pixels in the dominant color region to a total number of pixels; and
(ii) if the ratio calculated in step (c)(i) is not above a threshold value, classifying the shot in accordance with the ratio.

10. The method of claim 9, wherein step (c) further comprises:
(iii) if the ratio calculated in step (c)(i) is above the threshold value, performing the spatial composition on the dominant color region and using the spatial composition to classify the shot.

11. The method of claim 1, wherein step (d) comprises detecting the goal event in accordance with a template of characteristics which the goal event, if present, will satisfy.

12. The method of claim 11, wherein the template is applied starting with detection of a slow-motion replay.

13. The method of claim 12, wherein long shots are detected to define a beginning and an end of a break in which the goal, if present, will be shown.

14. The method of claim 13, wherein the template comprises an indication of all of: a duration of the break, an occurrence of at least one close-up or out-of-field shot, and an occurrence of at least one slow-motion replay shot.

15. The method of claim 1, wherein step (d) comprises detecting a referee by detecting a uniform color associated with the referee.

16. The method of claim 15, wherein step (d) further comprises forming horizontal and vertical projections of a region having the uniform color and determining from the horizontal and vertical projections whether the region corresponds to the referee.

17. The method of claim 1, wherein step (d) comprises detecting a penalty box.

18. The method of claim 17, wherein the penalty box is determined by:
(i) forming a mask region in accordance with the dominant color region;
(ii) within the mask region, detecting lines by edge response; and
(iii) from the lines detected in step (d)(ii), locating the penalty box by applying size, distance and parallelism constraints to the lines.

19. The method of claim 1, wherein the sports video sequence shows a soccer game.

20. The method of claim 1, wherein step (e) comprises performing video compression on the sports video sequence.

21. The method of claim 20, wherein the video compression comprises adjusting a bit allocation for each shot in accordance with a result of step (c).

22. The method of claim 20, wherein the video compression comprises adjusting a frame rate for each shot in accordance with a result of step (c).

23. The method of claim 22, wherein the video compression further comprises adjusting a bit allocation for each shot in accordance with a result of step (c).

24. A system for analyzing a sports video sequence, the system comprising:
an input for receiving the video sequence;
a computing device, in communication with the input, for:
(a) detecting a dominant color region in the video sequence;
(b) detecting boundaries of shots in the video sequence in accordance with color data in the video sequence;
(c) classifying at least one of the shots whose boundaries have been detected in step (b) through spatial composition of the dominant color region;
(d) detecting at least one of a goal event, a person and a location in the video sequence; and
(e) analyzing and summarizing the sports video sequence in accordance with a result of step (d); and
an output, in communication with the computing device, for outputting a result of step (e).

25. The system of claim 24, wherein the computing device performs step (a) with respect to a plurality of color spaces.

26. The system of claim 24, wherein the computing device performs step (a) by:
(i) determining a peak of each color component;
(ii) determining an interval around each peak determined in step (a)(i);
(iii) determining a mean color in each interval determined in step (a)(ii); and
(iv) classifying each pixel in the video sequence as belonging to the dominant color region or as not belonging to the dominant color region in accordance to the mean color in each interval determined in step (a)(iii).

27. The system of claim 26, wherein the computing device performs step (a)(iv) by determining a distance in color space between each pixel and the mean color.

28. The system of claim 24, wherein the computing device performs step (a) a plurality of times through the video sequence.

29. The system of claim 24, wherein the computing device performs step (b) by determining whether a first frame and a second frame are in a same shot or in different shots by:
(i) determining, for each of the first frame and the second frame, a ratio of pixels in the dominant color region to all pixels;
(ii) determining a difference between the ratio determined for the first frame and the ratio determined for the second frame; and
(iii) comparing the difference determined in step (b)(ii) to a first threshold value.

30. The system of claim 28, wherein the computing device performs step (b) further by:
(iv) computing a histogram intersection for the first frame and the second frame;
(v) computing a difference in color histogram similarity for the first frame and the second frame in accordance with the histogram intersection; and
(vi) comparing the difference in color histogram similarity to a second threshold value

31. The system of claim 30, wherein the second threshold value is selected in accordance with a type of shot whose boundaries are to be detected.

32. The system of claim 24, wherein the computing device performs step (c) by:
(i) calculating a ratio of a number of pixels in the dominant color region to a total number of pixels; and
(ii) if the ratio calculated in step (c)(i) is not above a threshold value, classifying the shot in accordance with the ratio.

33. The system of claim 32, wherein the computing device performs step (c) further by:
(iii) if the ratio calculated in step (c)(i) is above the threshold value, performing the spatial composition on the dominant color region and using the spatial composition to classify the shot.

34. The system of claim 24, wherein the computing device performs step (d) by detecting the goal event in accordance with a template of characteristics which the goal event, if present, will satisfy.

35. The system of claim 34, wherein the template is applied starting with detection of a slow-motion replay.

36. The system of claim 35, wherein long shots are detected to define a beginning and an end of a break in which the goal, if present, will be shown.

37. The system of claim 34, wherein the template comprises an indication of at least one of: a duration of the break, an occurrence of at least one close-up or out-of-field shot, and an occurrence of at least one slow-motion replay shot.

38. The system of claim 24, wherein the computing device performs step (d) by detecting a referee by detecting a uniform color associated with the referee.

39. The system of claim 38, wherein the computing device performs step (d) further by forming horizontal and vertical projections of a region having the uniform color and determining from the horizontal and vertical projections whether the region corresponds to the referee.

40. The system of claim 24, wherein the computing device performs step (d) by detecting a penalty box.

41. The system of claim 40, wherein the penalty box is determined by:
(i) forming a mask region in accordance with the dominant color region;
(ii) within the mask region, detecting lines by edge response; and
(iii) from the lines detected in step (d)(ii), locating the penalty box by applying size, distance and parallelism constraints to the lines.

42. The system of claim 24, wherein the computing device performs step (e) by performing video compression on the sports video sequence.

43. The system of claim 42, wherein the video compression comprises adjusting a bit allocation for each shot in accordance with a result of step (c).

44. The system of claim 42, wherein the video compression comprises adjusting a frame rate for each shot in accordance with a result of step (c).

45. The system of claim 44, wherein the video compression further comprises adjusting a bit allocation for each shot in accordance with a result of step (c).

46. A method for compressing a sports video sequence, the method comprising:
(a) classifying a plurality of shots in the sports video sequence;
(b) adjusting at least one of a bit allocation and a frame rate for each of the shots in accordance with a result of step (a); and
(c) compressing the sports video sequence in accordance with a result of step (b).

47. The method of claim 46, wherein:
step (a) comprises classifying the plurality of shots as long shots, medium shots or other shots; and
step (b) comprises assigning a maximum bit allocation or frame rate to the long shots, a medium bit allocation or frame rate to the medium shots and a minimum bit allocation or frame rate to the other shots.

48. A system for compressing a sports video sequence, the system comprising:
an input for receiving the sports video sequence;
a computing device, in communication with the input, for:
(a) classifying a plurality of shots in the sports video sequence;
(b) adjusting at least one of a bit allocation and a frame rate for each of the shots in accordance with a result of step (a); and
(c) compressing the sports video sequence in accordance with a result of step (b); and
an output, in communication with the computing device, for outputting a result of step (c).

49. The system of claim 48, wherein the computing device performs step (a) by classifying the plurality of shots as long shots, medium shots or other shots, and wherein the computing device performs step (b) by assigning a maximum bit allocation or frame rate to the long shots, a medium bit allocation or frame rate to the medium shots and a minimum bit allocation or frame rate to the other shots.
